(19) United States
(12) Patent Application Publication
(10) Pub. No.: US 2021/0227223 A1
(43) Pub. Date: Jul. 22, 2021

(54) SYSTEM AND METHODS FOR ARTIFICIAL INTELLIGENCE EXPLAINABILITY VIA SYMBOLIC GENERATIVE MODELING

(71) Applicant: GENERAL ELECTRIC COMPANY, Schenenctady, NY (US)

(72) Inventors: Alberto SANTAMARIA-PANG, Niskayuna, NY (US); Peter Henry TU, Niskayuna, NY (US); James KUBRICHT, Niskayuna, NY (US); Aritra CHOWDHURY, Niskayuna, NY (US); Arpit JAIN, Dublin, CA (US); Chinmaya DEVARAJ, Hyattsville, MD (US)

(21) Appl. No.: 16/748,275

(22) Filed: Jan. 21, 2020

(51) Int. Cl. H04N 19/136; G06N 3/04; G06N 3/08; H04N 19/172

(52) U.S. Cl. CPC H04N 19/136; G06N 3/0454; H04N 19/172; G06N 3/0445; G06N 3/084

(57) ABSTRACT

A system and method including receiving input data by an encoder, the encoder reducing a dimensionality of the received data; receiving, by a sender module, the reduced dimensionality data; generating, by the sender module, a sentence comprising a plurality of symbols representative of the input data, the symbols being defined by a predetermined vocabulary and a predetermined sentence length; receiving, by a receiver module, the sentence comprising the plurality of symbols; generating, based on the received sentence, continuous data by the receiver module; receiving, by a decoder, the continuous data from the receiver module; generating an output, by the decoder based on the continuous data, the output including a recreation of the input data.

### BACKGROUND

The field of the present disclosure generally relates to generative models, and more particularly, to aspects of an architecture and methods for generative models that represent data as semantically descriptive symbols.

Recent efforts in deep generative modeling have yielded impressive results, showcasing both the capabilities and as well as some limitations of variational autoencoders (VAEs) and generative adversarial networks (GANs). In some instances, VAEs and GANs have been used to generate high-resolution counterfeit images that are virtually indistinguishable by the naked eye from real images used as inputs to the VAEs and GANs. However, latent representations of data used in VAEs and GANs to generate images are generally uninterpretable by a human. Being uninterpretable, no additional insight regarding the input image and/or the modeling process may be gained by observing the latent representations.

Accordingly, in some respects, a need exists for methods and systems that provide an efficient and accurate mechanism for generative models to represent interpretable data.

### BRIEF DESCRIPTION OF THE DRAWINGS

FIG. 1 is an illustrative depiction of a generative model;

FIG. 2 is an illustrative architecture of a symbolic variational autoencoder (SVAE), in accordance with some embodiments;

FIG. 3 is an illustrative depiction of a representation of reconstructions of an example SVAE, in accordance with some embodiments;

FIG. 4 is an illustrative depiction of image reconstructions for a variety of example vocabularies and sentence lengths, in accordance with some embodiments;

FIGS. 5A and 5B are illustrative depictions of reconstructed images corresponding to symbol variations, in accordance with some embodiments herein; and

FIG. 6 is an illustrative depiction of a block diagram of computing system, according to some embodiments herein.

### DETAILED DESCRIPTION

Embodying systems and methods herein relate to generative models that, in general, have a goal of learning the true distribution of a set of data in order to generate new data points. Neural networks may be used to learn a function to approximate the model distribution to the true distribution. An autoencoder is one type of generative model and can be used to encode an input image into a lower dimensional representation that can store latent information about the input. A variational autoencoder (VAE) model may encode an input image into a lower dimensional representation storing latent information that can be used to generate images similar to the input image with some variability.

In some aspects, VAEs are generative models used to estimate the underlying data distribution from a set of training examples. A VAE may generally include an encoder that maps raw input to a latent variable z and a decoder that uses z to reconstruct the input. A loss function optimized in the VAE may a combination of (i) the KL (Kullback-Leibler) divergence loss between the latent encoding vector and a known reference (e.g., Gaussian) distribution and (ii) the reconstruction loss at the decoder. Training may be performed in an end-to-end manner with the help of a reparameterization process at the decoder that converts a non-differentiable node to a differentiable node to thereby allow for backpropagation.

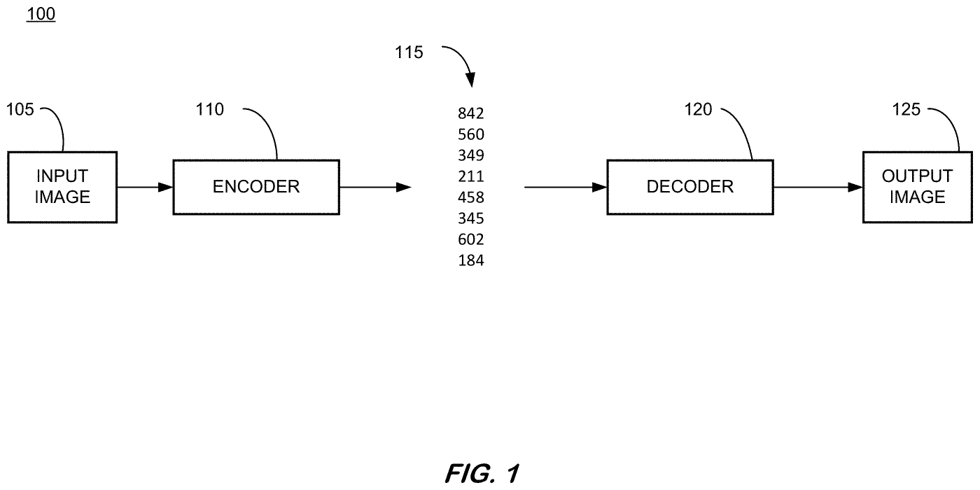

FIG. 1 is an illustrative example architecture diagram for a generative model 100. An input 105 to the model is an image that is encoded by encoder 110. Encoder 110 may be implemented by a neural network. Encoder 110 receives the input image and produces lower dimensional data 115 (e.g., an array of real numbers comprising 1×100 elements) storing latent information that represent the input image 105 (e.g., 1000 pixels×1000 pixels). The latent representations are uninterpretable. Being uninterpretable, a human cannot observe the latent representations and readily discern the meaning thereof and/or how they correlate to the input image. Decoder 120, also a neural network, receives the encoded latent representations (i.e., the lower dimensional data 115) and transforms it to an output 125 of the original image.

In some aspects, the present disclosure may present a number of features and concepts in the context of, for example, a VAE. However, the presented features and concepts may be applied in varying embodiments, including generative models in general unless otherwise specified.

In some embodiments, the present disclosure includes a Symbolic VAE (i.e., a SVAE). In some aspects, the SVAE disclosed herein may be viewed as an extension of a traditional VAE that includes key features on the hidden/latent state of the network. In some embodiments, these features may improve interpretability by capturing explainable image semantics within a discrete symbol space. In some regards similar to speech and language, discrete representations of latent information may provide several benefits. For example, discrete representations of latent information may be used to model salient classes in auditory/visual data, represent meaningful policies and states in reinforcement learning applications, and other use-cases and applications.

In some aspects, a distinct aspect of a SVAE herein is that latent symbols used to encode (e.g., an image) may serve as the building blocks for a learned private language. Given a sequence of discrete symbols (i.e., a sentence comprising the discrete symbols), systems and processes herein may directly decode the image that was used to generate the sentence. As a consequence, some symbols in a sentence might be manipulated to determine the “meaning” of each one. In some aspects, the present disclosure focuses on how objects in images are constructed, as opposed to how they are described.

Humans may typically use hierarchical labeling to describe entities in the world. WordNet appears to capture this property, where each word has many possible hypernyms (e.g., “color” is a hypernym of “red”). Hierarchical mappings in WordNet have improved interpretability significantly, helping to capture relationships between two words. Studies in neuroscience have also shown that rule-based hierarchical models can be used to explain cortical linguistic structure. It has even been shown that GAN-Tree uses a hierarchical structure to generate multi-modal data distributions. In some aspects, an SVAE disclosed herein may generate symbols following a learned grammar that is both hierarchical and explainable. Some embodiments use a discrete latent space to generate a hierarchical grammar via unsupervised learning methods. These mechanisms may effectively improve model explainability, as they provide greater control in generating data based on symbols. In some aspects, an SVAE herein might demonstrate how an image generated from a sentence of symbols varies as the symbols in the sentence are changed in a systematic manner. Based thereon, symbol manipulations may be associated with semantically noticeable changes in the reconstructed image, thereby effectively grounding the meaning of learned symbols.

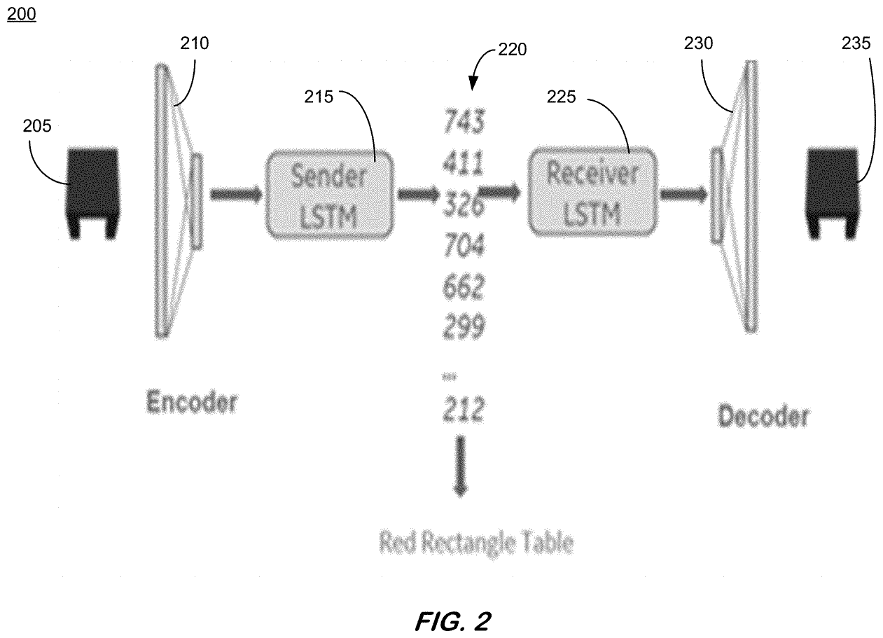

Referring to the system architecture of FIG. 2, the main components of a SVAE 200 in some embodiments herein includes an encoder 210 (e.g., a neural network), a sender module 215, a receiver module 225, and a decoder 230 (e.g., a neural network), where the input image 205 (e.g., a red table) is recreated as an output of the decoder. In the example of FIG. 2, let X be the data to be encoded. Here, we are interested in modeling the distribution PM. In a conventional VAE (e.g., FIG. 1), a latent distribution P(z) is learned that represents the data and this distribution is subsequently used to reconstruct X. For example, the input is passed through an encoder 110 that consists of either a CNN or multi-layer perceptron layers. The output is then passed through a reparameterization layer, followed by decoder 120. However, in a SVAE disclosed herein, the latent distribution is transformed into a discrete representation captured by a sequence of symbols. This aspect may be achieved by implementing a sender module that generates a sequence of symbols via an LSTM. The symbols produced by the sender LSTM 215 are passed into a receiver LSTM 225 that reconstructs the original feature embedding. The decoder module 230 transforms the reconstructed feature embedding into an image (i.e., output 135).

The array of numbers 220 in FIG. 2 each represent a symbol, wherein a sequence of symbols represents a semantically meaningful sentence. Herein, the context of the sentence corresponds to the context of the symbol in the input object. That is, the position of the symbols in the sentence matters. The inputs are encoded in terms of symbols that are effectively, part of a language. Moreover, processes and embodiments herein semantically encode the latent representation of the input in a manner that is semantically meaningful, interpretable (i.e., understandable) by humans.

In the present disclosure, a symbolic grounding problem is implemented in terms of the sender LSTM module that receives an input from an encoder and generates a sentence comprising a sequence of symbols (i.e., categorical data that is not continuous) and the receiver LSTM module receives the sentence that is then decoded to recreate the input image. Not insignificantly, the sender LSTM module implements backpropagation in the sender network by using a process to approximate differential data. In some aspects, the receiver LSTM and the decoder need not do anything to enable backpropagation since the sender LSTM fully addresses this issue. A receiver LSTM module herein may receive sentences from a sender LSTM module and produce continuous data that may be used by a decoder to recreate the original input image.

When these artificial intelligence (AI) agents are able to reconstruct the signal data from the symbols, then the system is referred to as being grounded. That is, if a SVAE herein is able to recreate the original image the sender LSTM receives based on the symbolic representation thereof by the receiver LSTM, then the sender LSTM and the receiver LSTM are grounded and able to communicate with each other via symbols.

In some embodiments, a SVAE herein may include a number of features to facilitate solving the symbolic grounding problem. In particular, (1) a vocabulary of a sequence of symbols is defined and (2) a length of a sentence comprising the symbols is defined. These constraints may operate to allow the sender LSTM and the receiver LSTM communicate with each other efficiently and accurately.

In some aspects, the present disclosure uses categorical symbols for sentences instead of continuous values; the generated sentences are semantically meaningful wherein the order of the symbols have a direct meaning corresponding to an input; and the input can be reconstructed (as the output) from the sequence of symbols and a human can understand the meaning of the symbols.

The SVAE of the present disclosure generates a sequence of symbols using a Long Short-Term Memory (LSTM) network. This is different than, for example, VAEs that use a discrete latent space (e.g., VQ-VAE and VQ-VAE2) wherein encoder output is quantized into one latent vector from an N-vector codebook. In some embodiments, the sequence of symbols generated by a SVAE herein follows a hierarchy where, for example, the first symbol in the sequence may capture the most discriminative information, such as class/category assignment. In some embodiments, later symbols in a sequence of symbols might represent finer details within the class, such as, for example, child nodes under a parent node. In using an LSTM, some embodiments might capture the grammar that underlies patterns of discrete symbols, rather than (explicitly) encoding the information in terms of independent symbols. This grammar, when effectively captured, may be used for other purposes such as, for example, generating variations of the same image by changing one or more of its associated symbols. As an example, multiple colors of an object could be visualized by varying one or more symbols in a sequence of symbols, even though the SVAE has not actually seen images corresponding to the multiple colors of the object during the training of the SVAE.

In some embodiments, the discrete latent factors symbols generated in one or more SVAEs herein are novel in that they also capture hierarchical representation.

In some embodiments, a SVAE herein may, in some aspects, be constructed with variational inference like some traditional VAEs.

In some embodiments, a process herein might train the entire deep neural network with the reconstruction loss and KL divergence loss as described in Equation 1 below. Parameters of the encoder, sender, receiver, and decoder modules are jointly optimized by backpropagation:

Loss= [symbol] [log [symbol] (X|z)]− [symbol] _{KL}[ [symbol] (z|X)| [symbol] (z)] (1)

where [symbol] [log [symbol] (X|z)] simplifies to taking binary cross entropy between reconstructed image and input image,
and [symbol] _{KL}[ [symbol] (z|X)[ [symbol] (z)] results in:

[symbol]

_{KL}[ [symbol] (μ(X),σ(X))| [symbol] (0,1)]]=½Σ[exp(σ(x)+μ²(X)−1−σ(X)]

It is noted that in some embodiments, simplifications are made by assuming P(z) to the normal distribution with mean 0 and standard deviation 1. In some aspects, the encoder and decoder consist of two fully connected layers. Since backpropagating gradients across discrete symbols is not possible, some embodiments utilize an estimator (e.g., Gumbel-Softmax) that results in a continuous gradient that is both stable and differentiable.

In some aspects, training a neural network with discrete intermediate outputs exhibits a number of challenges. For instance, standard backpropagation may only work on differentiable functions. Referring to FIG. 2, a sender LSTM module 215 of SVAE 100 is non-differentiable. To circumvent this issue, we use a process (e.g., reparameterization with Gumbbel-Softmax) to make the sender LSTM module 215 in the SVAE differentiable.

Instead of learning to describe imagery, the present disclosure focuses more on learning what constitutes an image so that whole images can be reconstructed using latent, symbolic representations.

Various aspects of the present disclosure relating to SVAEs have been tested on two image datasets: MNIST and FashionMNIST. Both datasets consist of about 60,000 training images and 10,000 test images. In a plurality of experiments, an encoder and decoder consisting of two fully-connected layers were used, reducing the dimension of the input image first to 400 and then to 20 in respective layers. The 20-dimensional feature from the last fully-connected layer of the encoder module was fed to a reparameterization layer. The output from the reparameterized layer was then provided to the sender module. The sender and seceiver components consist of a single LSTM unrolled based on the sequence length used in different settings. For example, the sender LSTM embedding dimension may be 256 and the hidden layer dimension may be 512. The temperature parameter in Gumbel Softmax is 1. Adam (or another optimization process or algorithm) optimizer was used with a learning rate set to 1e−5.

In some aspects, conducted experiments show that discrete symbols capture the semantic properties of an image and can be used to unearth underlying primitives. Without any supervision, it was observed that each symbol represents a concept. As outlined in detail below, the generated symbols form a grammar with useful semantic properties.

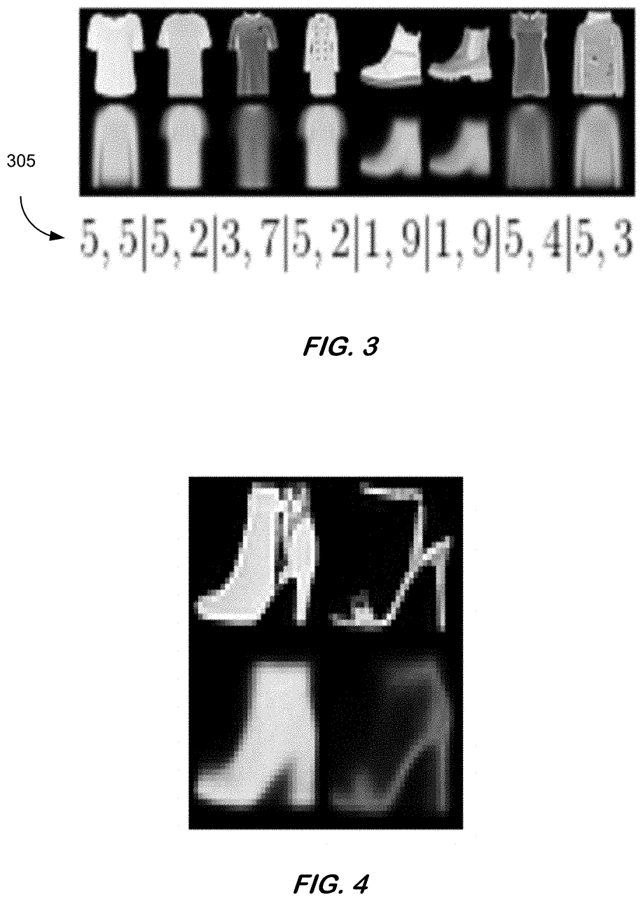

FIG. 3 is an illustrative depiction of a representation of reconstructions from a SVAE in accordance with some embodiments herein trained on the FashionMNIST dataset. This network was trained with a vocabulary size of 10 symbols and a sentence length of 2, where vocabulary size refers to the possible number of symbols present in the dictionary. It was observed that even with a small sentence and vocabulary size, the network can faithfully reproduce the input test data. By way of example, the corresponding symbols or sentences that a SVAE produced are shown in FIG. 3 at 305. It is seen that the first symbol 5 corresponds with shirts, as is evident from the 1^{st}, 2^{nd}, 4^{th}, 7^{th}, and 8^{th} column images (left to right). In addition, the symbol 1 is associated with the concept of shoes. The second symbol in the sentence encodes the different types of garments (e.g., shirts, shoes, dresses). The 3^{rd} column image in the the example of FIG. 3 is incorrectly reconstructed as trousers. Therefore, the symbol is 3 instead of 5.

As depicted in FIG. 4, increasing the vocabulary size to 100 in the left column of FIG. 4 allows for richer representations and better reconstructions of images, as compared to the right column images recreated using a vocabulary of 20 symbols. This follows the principle of image compression where a lossy image has a lesser number of bits. However, as the vocabulary size and sentence length is increased, it becomes difficult to qualitatively interpret the exact semantic meaning of each symbol through a visualization only. Still, the first symbol in the sentence continues to refer to class membership.

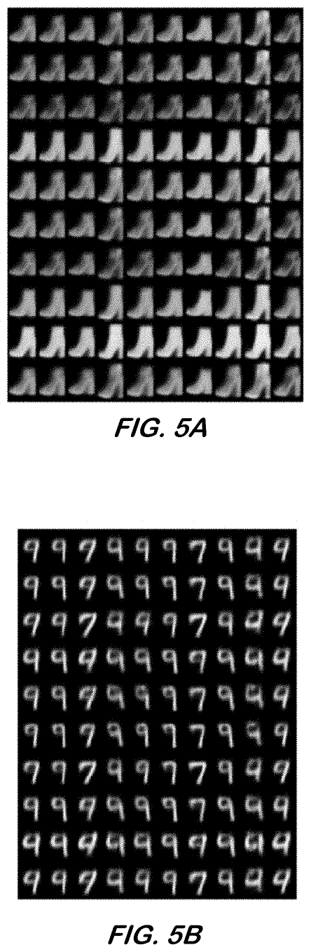

Another set of experiments trained a SVAE in accordance with the present disclosure with a vocabulary size of 20 and a sentence length of 3. FIG. 5A shows the output for the FashionMNIST dataset when the first symbol is fixed at 15 and the remaining two symbols in the sentence are exhaustively explored. Results indicate that symbol 15 is associated with a high-heeled shoe. This suggests that the first symbol in the sentence indicates the broad category in the dataset and the second and third symbols indicate changes in intensity and shape. This further implies that there is a grammar underlying the composed sentences. That is, the symbols and their order in a sentence have meaning.

A similar result is obtained when the same experiment was performed using different dataset (e.g., the MNIST dataset), as seen in FIG. 5B. In this example, the first symbol 15 shows a representation of the input number 9. Changing the remaining two symbols in the sentence shows different types and shapes of the number 9. It is also seen that some 7's are include in certain positions in the grid, which could be due to the fact that the number 7 looks visually similar to the number 9. Therefore, symbol 15 could actually be encoding the shape of both 9 and 7. It is noted however that a SVAE herein offers advantages of visualizing the latent space compared to, for example, Vq-VAE. By using a hierarchy in symbols, encodings using small vocabulary sizes may be explored while taking advantage of longer sentence lengths.

Compared to, for example, Vq-VAE, aspects of the present disclosure provide better control over generated images because of the added advantage of using sentences instead of a single bit. Thus, aspects of the present disclosure include a systematic methodology of generating images by exhausting all possible symbols of the given vocabulary size and sentence length.

In some aspects and embodiments, the SVAE presented herein provides the benefits and practical application(s) of interpretability and the ability to generate images by varying symbolic encodings. It is noted that the generated symbols form a grammar, where the first symbol might refer to the class of the image, and the next set of symbols express finer features. By exhausting all possible symbol sequences for a given category, it has been demonstrated that the how finer characteristics are captured in a hierarchical fashion. These aspects provide a foundation that supports an understanding of what the primitives of images are and how each primitive might affect the appearance of various image types.

In some aspects while the success of deep learning methods have provided exciting new ways to transform data into useful representations, explainability remains a critical problem. In particular, human interfacing with artificial agents relies on modes of communication that can be interpreted by both parties. Significantly, the SVAE disclosed herein provides a framework by implementing a symbolic method for encoding raw data, wherein each symbol appears to have some meaning to human observers (e.g., a “red shoe” versus a “white shoe”).

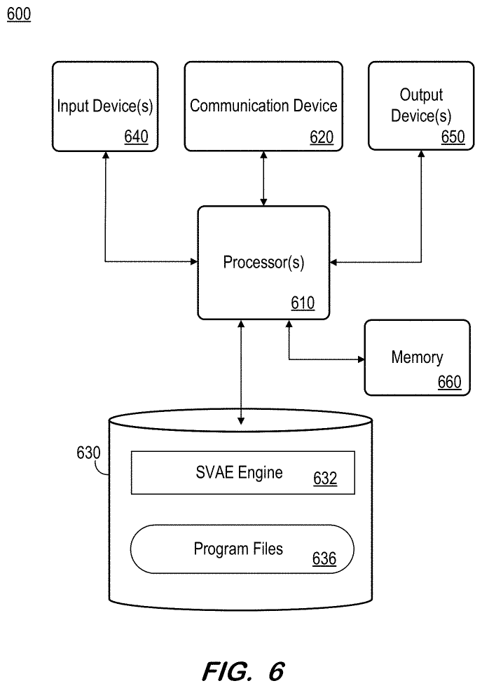

FIG. 6 is a block diagram of computing system 600 according to some embodiments. System 600 may comprise a general-purpose or special-purpose computing apparatus and may execute program code to perform any of the methods, operations, and functions described herein. System 600 may comprise an implementation of one or more systems (e.g., a sender LSTM module, a receiver LSTM module, etc.) for a SVAE system or parts thereof, etc. and processes executed thereby. System 600 may include other elements that are not shown, according to some embodiments.

System 600 includes processor(s) 610 operatively coupled to communication device 620, data storage device 630, one or more input devices 640, one or more output devices 650, and memory 660. Communication device 620 may facilitate communication with external devices, such as a data server and other data sources. Input device(s) 640 may comprise, for example, a keyboard, a keypad, a mouse or other pointing device, a microphone, knob or a switch, an infra-red (IR) port, a docking station, and/or a touch screen. Input device(s) 640 may be used, for example, to enter information into system 600. Output device(s) 650 may comprise, for example, a display (e.g., a display screen) a speaker, and/or a printer.

Data storage device 630 may comprise any appropriate persistent storage device, including combinations of magnetic storage devices (e.g., magnetic tape, hard disk drives and flash memory), optical storage devices, Read Only Memory (ROM) devices, etc., while memory 660 may comprise Random Access Memory (RAM), Storage Class Memory (SCM) or any other fast-access memory. Files including, for example, generative model representations (e.g., VAE, GAN, etc.), training datasets, output records (e.g., generated recreated images), reparameterization process(es)/models herein, and other data structures may be stored in data storage device 630.

SVAE engine 632 may comprise program code executed by processor(s) 610 (and within the execution engine) to cause system 600 to perform any one or more of the processes or portions thereof disclosed herein to effectuate a SVAE or other symbolic generative model. Embodiments are not limited to execution by a single apparatus. Data storage device 630 may also store data and other program code 636 for providing additional functionality and/or which are necessary for operation of system 600, such as device drivers, operating system files, etc.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods disclosed herein, such as a method of determining a design a part and a combination of a thermal support structure and a structural support structure.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

What is claimed is:

1. A computer-implemented method, the method comprising:
receiving input data by an encoder, the encoder reducing a dimensionality of the received data;
receiving, by a sender module, the reduced dimensionality data;
generating, by the sender module, a sentence comprising a plurality of symbols representative of the input data, the symbols being defined by a predetermined vocabulary and a predetermined sentence length;
receiving, by a receiver module, the sentence comprising the plurality of symbols;
generating, based on the received sentence, continuous data by the receiver module;
receiving, by a decoder, the continuous data from the receiver module;
generating an output, by the decoder based on the continuous data, the output including a recreation of the input data.

2. The method of claim 1, wherein the input data is at least one of an image, textual data, video, and auditory data.

3. The method of claim 1, wherein the sender module implements backpropagation on the received input data using a process to at least approximate differential data.

4. The method of claim 1, wherein each of the symbols are discrete representations correlated to at least a portion of the input data.

5. The method of claim 1, wherein the sender module is implemented, at least in part, by a Long Short-Term Memory network.

6. The method of claim 1, wherein the sentence comprising the plurality of symbols representative of the input data further includes a hierarchical representation of the input data.

7. The method of claim 1, wherein the sender module and the receiver module are sematically grounded with respect to each other.

8. The method of claim 2, wherein the input data is at least one of the image and the video and the generating of the output includes reconstructing the at least one of the image and the video of the input data from the continuous data.

9. The method of claim 2, wherein the generating of the plurality of symbols representative of the input data of at least one of the image and the video compresses the image and the video.

10. A system comprising:
a memory storing processor-executable instructions; and
a processor to execute the processor-executable instructions, within an integrated development environment application, to cause the system to:
receive input data by an encoder, the encoder reducing a dimensionality of the received data;
receive, by a sender module, the reduced dimensionality data;
generate, by the sender module, a sentence comprising a plurality of symbols representative of the input data, the symbols being defined by a predetermined vocabulary and a predetermined sentence length;
receive, by a receiver module, the sentence comprising the plurality of symbols;
generate, based on the received sentence, continuous data by the receiver module;
receive, by a decoder, the continuous data from the receiver module;
generate an output, by the decoder based on the continuous data, the output including a recreation of the input data.

11. The system of claim 10, wherein the input data is at least one of an image, textual data, video, and auditory data.

12. The system of claim 10, wherein the sender module implements backpropagation on the received input data using a process to at least approximate differential data.

13. The system of claim 10, wherein each of the symbols are discrete representations correlated to at least a portion of the input data.

14. The system of claim 10, wherein the sender module is implemented, at least in part, by a Long Short-Term Memory network.

15. The system of claim 10, wherein the sentence comprising the plurality of symbols representative of the input data further includes a hierarchical representation of the input data.

16. The system of claim 10, wherein the sender module and the receiver module are semantically grounded with respect to each other.

17. The system of claim 11, wherein the input data is at least one of the image and the video and the generating of the output includes reconstructing the at least one of the image and the video of the input data from the continuous data.

18. The system of claim 11, wherein the generating of the plurality of symbols representative of the input data of at least one of the image and the video compresses the image and the video.
